(19) United States
(12) Patent Application Publication
(10) Pub. No.: US 2021/0203051 A1
(43) Pub. Date: Jul. 1, 2021

(54) MICROWAVE CIRCULATOR BASED ON DIELECTRIC WAVEGUIDES

(71) Applicant: Eagantu Ltd., Ra'anana (IL)

(72) Inventors: Michael DAKHIYA, Tel Aviv (IL); Roman JOFFE, Netanya (IL)

(73) Assignee: Eagantu Ltd., Ra'anana (IL)

(21) Appl. No.: 16/731,529

(22) Filed: Dec. 31, 2019

(51) Int. Cl. H01P 1/383; H01P 3/16; H01P 3/12

(52) U.S. Cl. CPC H01P 1/383; H01P 3/12; H01P 3/16

(57) ABSTRACT

A radio frequency (RF) circulator comprising a dielectric element and a ferrite element. The dielectric element has a dielectric constant that is correlated to the dielectric constant of the ferrite element, and both the dielectric element and the ferrite elements each have at least a partial conductive coating. In an embodiment, interior of the circulator includes a plurality of excitation pins placed therein.

### TECHNICAL FIELD

The present disclosure relates generally to microwave circulators, and more specifically to microwave circulators that are based on dielectric waveguides.

### BACKGROUND

Circulators are passive devices that are essential tools in controlling, manipulating and directing radio frequency (RF) signals. As shown in FIG. 1, a circulator 100 receives an input signal at a first port 110, and outputs the signal at a second port 120, receives an input signal at the second port 120, and outputs the signal at a third port 130, and receives an input signal at the third port 130, and outputs the signal at the first port 110.

Circulators contain three or more ports and are configured to be unidirectional and non-reciprocal, such that an input signal of a first port 110 is forwarded as an output signal of a second port 120, but an input signal of the second port 120 is rotated to a third port 130, rather than returned to the first port 110. In some embodiments, a circulator may be configured to be used as an isolator (not shown), when one of the ports is terminated with a matched load. Thus, a signal received at the first port 110 of the isolator circulator is output at the second port 120, but an input signal to the second port 120 is terminated and not output to the first port 110.

The most common type of circulators are ferrite circulators which are composed of ferrite materials and magnets which determine the direction of the signal flow. The interaction of the magnet's magnetic field with the ferrite material creates a directional field in either a clockwise or counterclockwise direction, in relation to the circulator ports. These circulators are often divided into two types: a waveguide embodiment, and a strip line embodiment. The waveguide embodiment, an example of which is shown in FIG. 2, employs waveguides connected to the ports to carry RF signals either to or away from a circulator port, while the strip line embodiment (not shown) employs strip lines as a medium to carry the RF signals to and away from the circulator. The waveguides are a hollow metal pipe 215 connected to a flange 210 of the circulator port, e.g., port 1, port 2, or port 3, and are configured to carry the RF signals therein to a second device. Either embodiment may be configured as a Y-junction circulator having three ports, where a permanent magnet produces a magnetic flux within the circulator.

FIG. 3 is a schematic diagram 300 of how an RF signal may propagate through a waveguide 310. The propagation of certain electromagnetic modes is shown within a rectangular waveguide 310. A TE mode 320 is dependent upon the transverse electric waves, also referred to as H waves, characterized by the fact that the electric vector (E) of the electric field 325 is always perpendicular to the direction of propagation 340. A TM mode 320 includes transverse magnetic waves, also referred to as E waves, that are characterized by the fact that the magnetic vector (H vector) of the magnetic field 335 is always perpendicular to the direction of propagation 340.

Current designs of circulators, however, require a high production cost for manually assembling and calibrating each circulator, as well as requiring physically large dimensions, both in width and in height.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a microwave circulator based on dielectric waveguides, comprising: a dielectric element having three or more ports forming a waveguide; and a ferrite element placed within the dielectric element; wherein a dielectric constant of the dielectric element is correlated to a dielectric constant of the ferrite element.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a circulator.

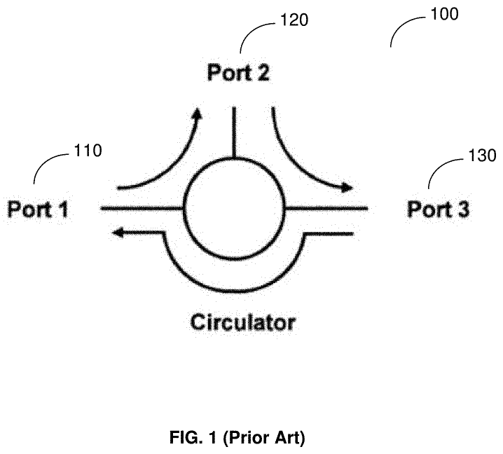

FIG. 2 is an example of a waveguide circulator.

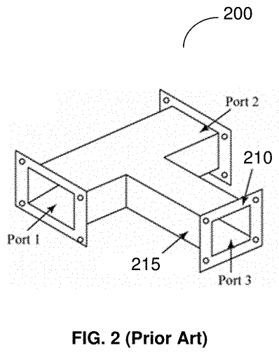

FIG. 3 is a schematic diagram of electric and magnetic fields within waveguides.

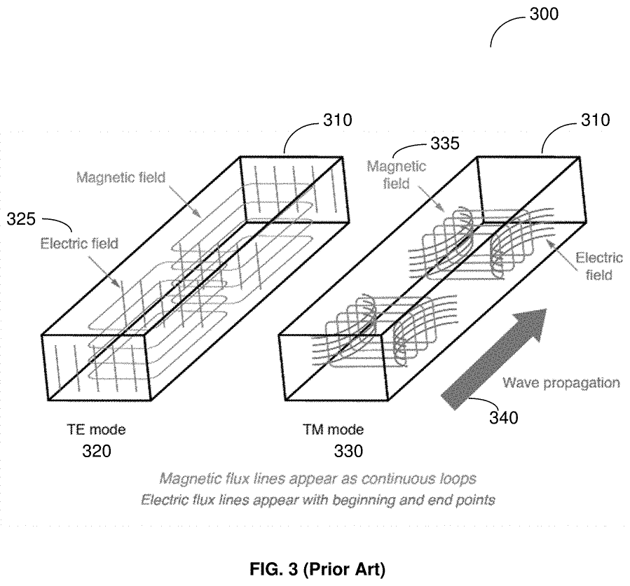

FIGS. 4A-4C are schematic diagrams of circulators including ferrite and dielectric elements according to various embodiments.

FIGS. 5A-5B are schematic diagrams of the dielectric element of the circulator according to an embodiment.

FIG. 6 is a schematic diagram of the ferrite element of the circulator according to an embodiment.

FIG. 7 is a schematic diagram of the interior of the circulator with excitation pins according to an embodiment.

FIG. 8 is a schematic diagram of a portion of a waveguide with a microstrip according to an embodiment.

FIG. 9 is a graph of insertion loss, return loss, and isolation between port of the disclosed circulator.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments are directed to an RF circulator that includes both a dielectric element and a ferrite element.

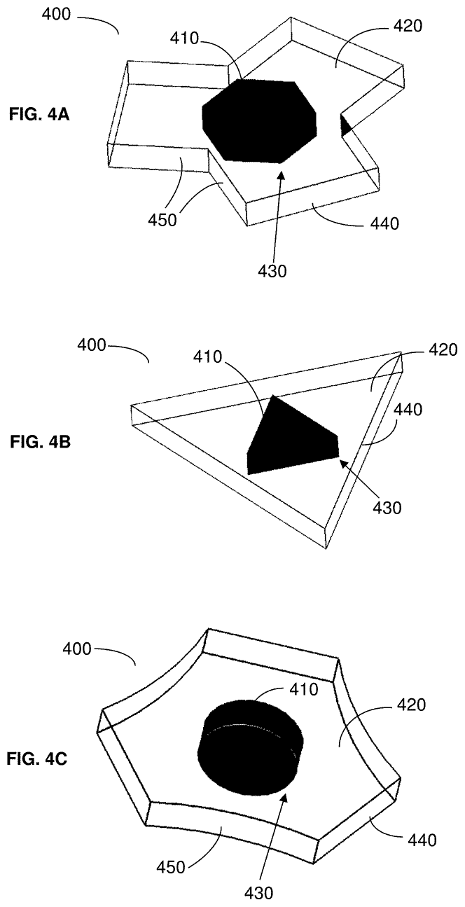

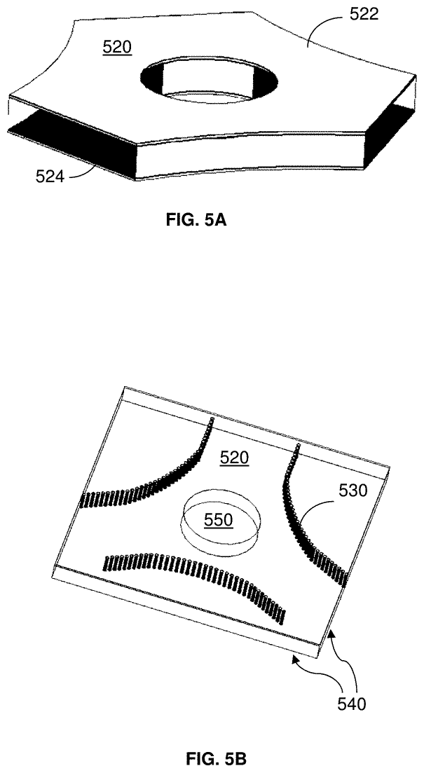

FIG. 4A-4C are schematic diagrams of circulators 400 that include both ferrite 410 and dielectric 420 elements, according to various embodiments. The dielectric element 420 has a dielectric constant that is correlated to the dielectric constant of the ferrite element 410, and has at least a partially conductive coating as discussed below in FIG. 5A. The general formula for the correlation of the dielectric constants of the ferrite element and the dielectric element may be derived from the boundary condition for the dielectric-ferrite boundary, where dielectric constant of the dielectric element is related to the wave number Kₐ, and dielectric constant of the ferrite element is related to the wave number k_{f}, where the wave number K is defined as k=\sqrt{ωμε}, where ε is the corresponding dielectric constant. The formula may be represented as follows:

$${( \frac{{k}_{f}}{{μ}_{e}} )}^{2} + {( \frac{κβ}{{μμ}_{e}} )}^{2} - {k}_{a} cot {k}_{a} c ( \frac{{k}_{f}}{{μ}_{0} {μ}_{e}} cot {k}_{f} t + \frac{κβ}{{μ}_{0} {μμ}_{e}} ) - {( \frac{{k}_{a}}{{μ}_{0}} )}^{2} \times cot {k}_{a} c cot {k}_{a} d - {k}_{a} cot {k}_{a} d ( \frac{{k}_{f}}{{μ}_{0} {μ}_{e}} cot {k}_{f} t - \frac{κβ}{{μ}_{0} {μμ}_{e}} ) = 0.$$

The dielectric element further includes three or more ports, where each port of the circulator 400 includes a planar surface 440 and may further include a number of closed edges 450.

The ferrite element 410 is placed within the dielectric element 420 and has a dielectric constant that is correlated to the dielectric constant of the dielectric element 420. The shape of the ferrite element 410 corresponds to the shape of the closed edges 450 of the dielectric element 420 and to the ratio of the dielectric constants of the ferrite and dielectric materials. There are four parameters that are considered: the dielectric constant of the ferrite element, the dielectric constant of the dielectric element, the shape of the ferrite element, and the shape of the dielectric element. The first two parameters depend on the chosen materials, while the last two parameters are derived from associated Maxwell equations in order that the prime electromagnetic mode will be propagated in the waveguide without reflection. Maxwell equations for the two first parameters and the chosen last two parameters can be performed numerically with a finite element method solver, such as HFSS (High-Frequency Structure Simulator) or similar software.

In an embodiment, the closest surface 430 of the ferrite element 410 to a port is positioned facing toward the planar surface 440 of the closest port of the circulator 400. FIG. 4A shows a hexagon shaped ferrite element 410 with vertexes pointing toward the center of the closest port according to an embodiment. In a further embodiment, shown in FIG. 4B, both the ferrite element 410 and the dielectric element 420 are triangular shaped, where the corner points 430 of the ferrite element 410 are aligned with the center of the planar surfaces 440 of the dielectric element 420. In yet a further embodiment, shown in FIG. 4C, the ferrite element 410 is circular shaped, where the closest distance between the ferrite element 410 and each port is equidistant.

FIG. 5A-5B are schematic diagrams of the dielectric element 520 of the circulator according to various embodiments. The dielectric element 520 of the circulator includes conductive coatings on a top surface 522 and on a parallel and bottom surface 524 thereof.

In an optional embodiment, shown in FIG. 5B, the dielectric element 520 includes an array of conductive metallized vias 530. A waveguide is formed within the dielectric element 520, where the external boundary of the waveguide is the external edge 540 of the dielectric element 520 or the array of metallized vias 530. The internal boundary of the waveguide is a central opening 550 where the ferrite element is placed. The shape of the dielectric element 520 is configured to produce a waveguide for specific electromagnetic modes and wavelengths, as desired and required per application.

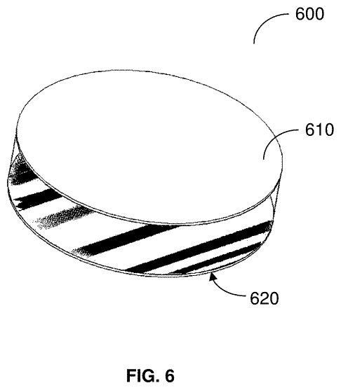

FIG. 6 is a schematic diagram of the ferrite element 600 of the circulator according to an embodiment. Similar to the dielectric element 520 discussed above in FIG. 5, the ferrite element 600 includes conductive coatings on a top surface 610 and on a parallel and bottom surface 620.

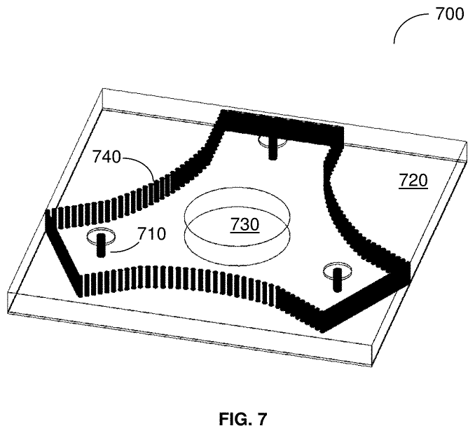

FIG. 7 is a schematic diagram of the interior of the circulator 700 with excitation pins 710 according to an embodiment. In an embodiment, excitation of the waveguide (not shown) within the circulator 700 which controls the input and output of an electromagnetic wave is achieved with metal excitation pins 710 inserted into the dielectric element 720. A high frequency voltage signal is applied to the excitation pins 710 to create the excitation. The excitation pins 710 may be terminated with SMA connectors, BGA balls, LGA pads or similar connecting parts, and extend from a bottom surface to a top surface of the dielectric element 720. In an embodiment, the excitation pins 710 extend though the conductive metallized vias discussed above in FIG. 5.

In an embodiment, the excitation of the waveguides is accomplished with three metal pins 710 for a three-port circulator 700. A magnetic field is applied in a direction parallel to the axis of the cylindrical ferrite element 730. To achieve the magnetic field, a small permanent magnet is attached to the top or the bottom surface of the ferrite element 730.

As a non-limiting exemplary embodiment, a dielectric element 720 can measure 7 mm by 7 mm by 0.5 mm, is constructed out of ceramic material, and possesses a dielectric constant of 250. The ferrite element 730 can be a cylinder with dimensions of 1.5 mm in diameter and 0.5 mm in height, with a dielectric constant of approximately 20, and the vias 740 are cylinders, each with a diameter of 200 microns.

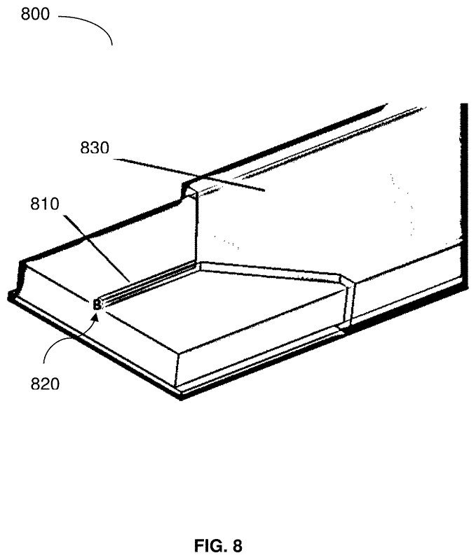

FIG. 8 is a schematic diagram of a portion of a waveguide 800 with a microstrip according to an embodiment. The excitation of the circulator may be further achieved with a microstrip 810 that is matched, by its impedance, to the waveguide 830. An SMA connector can be attached to the edge 820 of the microstrip.

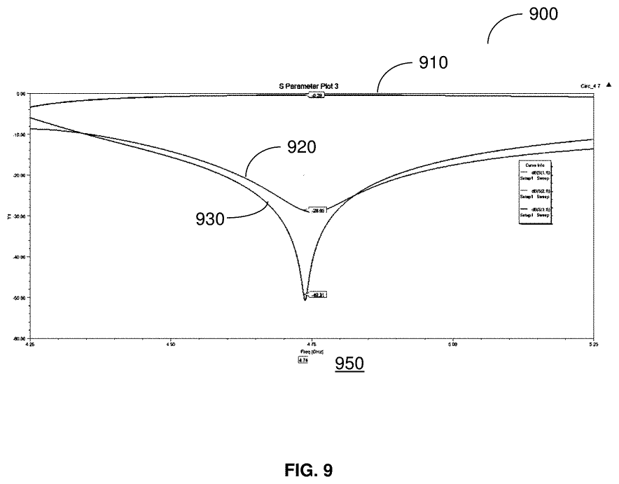

FIG. 9 is an example graph 900 of insertion loss, return loss, and isolation between port of the circulator as a function of frequency 950. As shown in the graph 900, performance of a miniature microwave circulator, as described herein and based on dielectric waveguides, includes minimal insertion loss 910, with a return loss 920, and significant isolation between ports 930.

The microwave circulator disclosed herein can be integrated in hand-held devices such as, but not limited to, a cellular telephone, a smartphone, a tablet computer, a laptop computer, a wearable electronic device, and the like. The RF circulator can also be integrated into other communication devices, such as radars, e.g., for an autonomous vehicle, a base-station, routers, and so on.

In an embodiment, the bandwidth of the microwave circulator disclosed herein is between 1 gigahertz (GHz) and 7 GHz, where the operating frequency of the RF circulator includes a plurality of distinct frequency bands.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A microwave circulator based on dielectric waveguides, comprising:
a dielectric element having three or more ports forming a waveguide; and
a ferrite element placed within the dielectric element;
wherein a dielectric constant of the dielectric element is correlated to a dielectric constant of the ferrite element.

2. The microwave circulator of claim 1, wherein the dielectric element further includes:
at least one partially conductive coating on at least one of a top surface and a parallel bottom surface of the dielectric element.

3. The microwave circulator of claim 1, wherein a shape of the ferrite element and a shape of the dielectric element are each derived from an associated Maxwell equation such that a prime electromagnetic mode will be propagated in the waveguide without reflection.

4. The microwave circulator of claim 1, wherein each of the three or more ports of the dielectric element includes a planar surface.

5. The microwave circulator of claim 4, wherein a closest surface of the ferrite element to a port of the three or more ports of the dielectric element is positioned facing toward the planar surface of a closest port of the microwave circulator.

6. The microwave circulator of claim 1, wherein the dielectric element further includes an array of conductive metallized vias placed therein.

7. The microwave circulator of claim 6, wherein the array of conductive metallized vias further include excitation pins, wherein a magnetic field is applied in a direction parallel to an axis of the ferrite element.

8. The microwave circulator of claim 1, further comprising:
a microstrip attached to the waveguide, wherein an excitation of the microwave circulator is achieved with the microstrip having an impedance matching an impedance of the waveguide.
